(19) United States
(12) Patent Application Publication
(10) Pub. No.: US 2005/0225282 A1
(43) Pub. Date: Oct. 13, 2005

(54) Giant magnetoresistive cell monitoring

(76) Inventor: Scott Dewey, Dansville, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 10/823,305

(22) Filed: Apr. 13, 2004

(51) Int. Cl. H02J 7/32

(52) U.S. Cl. 320/101

(57) ABSTRACT

A fuel cell monitoring system for monitoring the voltage output of the fuel cells in a fuel cell stack. The monitoring system includes a wheatstone bridge having at least one giant magnetoresistive thin film device. The system further includes a switching network that selectively couples each cell to a conductive trace so that the current generated by the cell flows through the trace. The trace runs proximate to the wheatstone bridge so that the magnetic field generated by the current flow causes the magnetoresistive device to decrease its resistance, and thus, unbalance the wheatstone bridge. The unbalanced bridge provides a voltage potential that is detected and amplified by a differencing amplifier. The output of the amplifier is representative of the voltage output of the fuel cell.

### BACKGROUND OF THE INVENTION

1. Field of the Invention

This invention relates generally to a monitoring system for monitoring the voltage output of the fuel cells in a fuel cell stack and, more particularly, to a monitoring system for monitoring the voltage output of the fuel cells in a fuel cell stack, where the monitoring system employs a giant magnetoresistive wheatstone bridge.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is disassociated in the anode, with the aid of a catalyst, to generate free hydrogen protons and electrons. The hydrogen protons pass through the electrolyte to the cathode. The hydrogen protons react with the oxygen and the electrons in the cathode, with the aid of a catalyst, to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. The PEMFC generally includes a solid polymer electrolyte proton conducting membrane, such as a perfluorinated acid membrane. The anode and cathode typically include finely divided catalytic particles, usually platinum (Pt), supported on carbon particles and mixed with an ionomer. The combination of the anode, cathode and membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Many fuel cells are typically combined in a fuel cell stack to generate the desired power. The fuel cell stack receives a cathode charge gas that includes oxygen, and is typically a flow of forced air from a compressor. Not all of the oxygen in the air is consumed by the stack and some of the air is output as a cathode exhaust gas that may include water as a stack by-product. Also, the fuel cell stack receives an anode hydrogen gas.

Each fuel cell in the fuel cell stack includes opposing bipolar plates having flow channels through which the anode gas, the cathode gas and a cooling fluid flow. A cell membrane is positioned between the bipolar plates in each fuel cell, and receives the cathode gas and the anode gas to generate the electricity in the manner discussed above. The bipolar plates are conductive members, such as stainless steel, that are coupled in series and collect the electrical current generated by the fuel cell stack to be output therefrom. In a typical fuel cell stack for an automotive application, there are about 200 fuel cells, and thus, about 200 bipolar plates.

It is necessary to monitor the output voltage of each fuel cell during operation of the fuel cell stack to ensure that each fuel cell is operating properly. If one of the fuel cells in the stack is not generating the proper amount of current, appropriate action needs to be taken or the entire stack could be damaged. Currently, the differential output of each fuel cell is measured using a high impedance operational amplifier.

The giant magnetoresistive phenomenon is a well known phenomenon where a large decrease in the resistance of a specially constructed thin film resistive device is observed when a magnetic field is applied to the thin film device. The device includes layers of resistors and non-magnetic materials. The size of the decrease in resistance can be 10-20% and higher in giant magnetoresistant materials with multiple non-magnetic layers.

### SUMMARY OF THE INVENTION

In accordance with the teachings of the present invention, a fuel cell monitoring system is disclosed for monitoring the voltage output of the fuel cells in a fuel cell stack. The monitoring system includes a wheatstone bridge having at least one giant magnetoresistive thin film device. The system further includes a switching network that selectively and separately couples each cell to a conductive trace so that the current generated by the cell flows through the trace. The trace runs proximate to the wheatstone bridge so that the magnetic field generated by the current flow causes the magnetoresistive device to decrease its resistance, and thus, unbalance the wheatstone bridge. The unbalanced bridge provides a voltage potential that is detected and amplified by a differencing amplifier. The output of the amplifier is representative of the voltage output of the fuel cell.

Additional advantages and features of the present invention will become apparent from the following description and appended claims, taken in conjunction with the accompanying drawings.

### BRIEF DESCRIPTION OF THE DRAWINGS

FIG. 1 is a schematic diagram of a wheatstone bridge circuit;

FIG. 2 is a schematic diagram of a wheatstone bridge circuit, where one of the resistors is a giant magnetoresistive resistor;

FIG. 3 is a schematic diagram of a cell monitoring system for monitoring the voltage potential of the fuel cells in a fuel cell stack, where the system uses the giant magnetoresistive phenomenon, according to an embodiment of the present invention;

FIG. 4 is a detailed schematic diagram of a cell monitoring circuit for monitoring the voltage potential of the fuel cells in a fuel cell stack, where the system uses the giant magnetoresistive phenomenon, according to another embodiment of the present invention;

FIG. 5 is a schematic diagram of a charge pump circuit employed in the circuit shown in FIG. 4; and

FIG. 6 is a schematic diagram of a motherboard employed in the circuit shown in FIG. 4.

### DETAILED DESCRIPTION OF THE EMBODIMENTS

The following discussion of the embodiments of the invention directed to a cell monitoring system for monitoring the voltage output of the fuel cells in a fuel cell stack, where the system uses the giant magnetoresistive phenomenon, is merely exemplary in nature, and is in no way intended to limit the invention or its applications or uses.

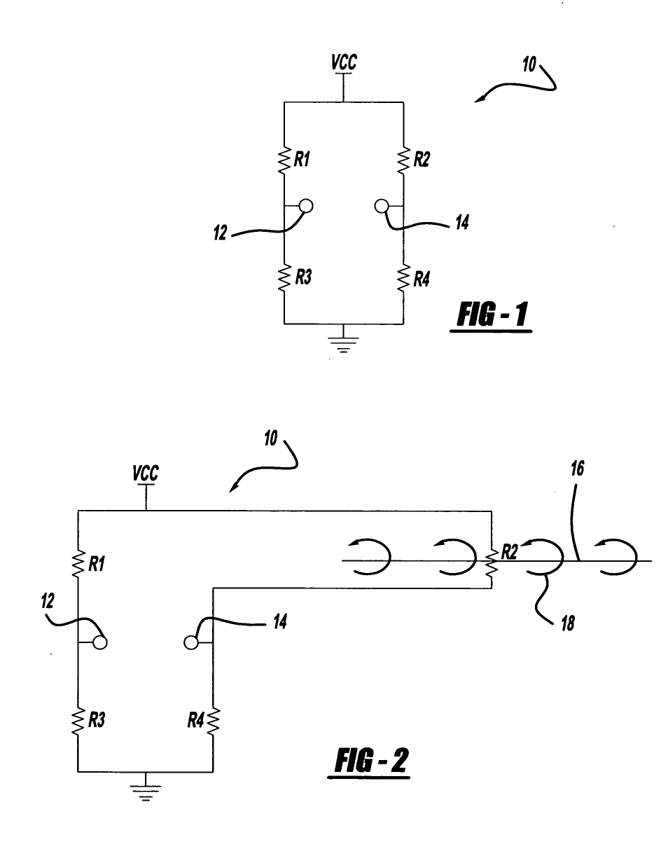

The present invention is a monitoring system that employs the giant magnetoresistive phenomenon to determine the state or health of the fuel cells in a fuel cell stack. A giant magnetoresistive device is use to upset the balance of a wheatstone bridge to measure the cell voltage. FIG. 1 is a general schematic diagram of a wheatstone bridge 10 employing resistors R₁, R₂, R₃ and R₄, where the resistor R₂ is a giant magnetoresistive device. If the resistances of all of the resistors R₁-R₄ are equal the voltage at nodes 12 and 14 is the same.

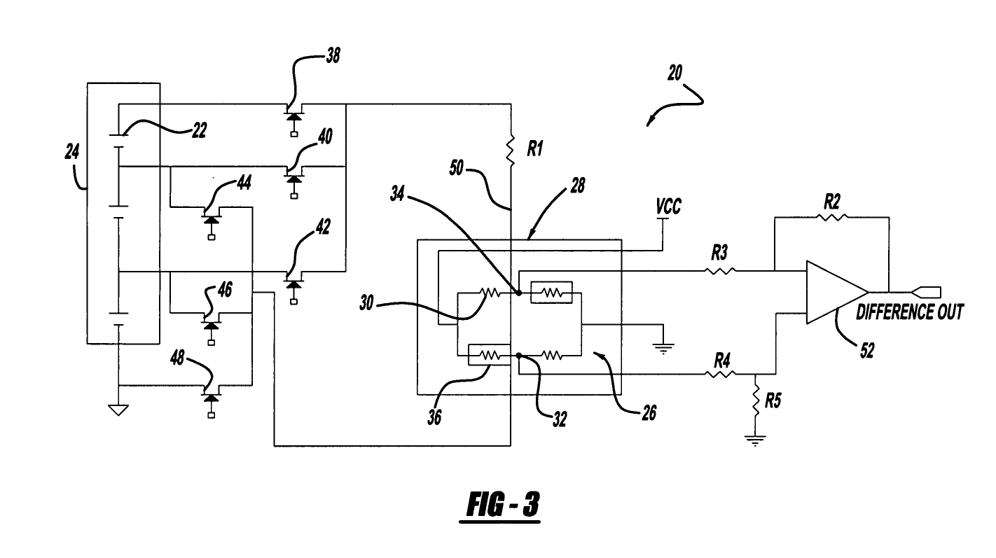

If an isolated current carrying conductor 16, as shown in FIG. 2, is placed near the magnetoresistive resistor R₂, the resistance of the resistor R₂ will decrease as a result of the magnetic field 18 generated by the current and the giant magnetoresistive phenomenon. This decrease in the resistance of the resistor R₂ is proportional to the magnitude of the magnetic field 18 applied to the resistor R₂. The magnitude of the magnetic field 18 is proportional to the current through the conductor 16. The decrease in the resistance of the resistor R₂ as the current increases is a linear operation within the operating range of the fuel cell based on the particular design of the device. When the resistance of the resistor R₂ decreases, it upsets the balance of the wheatstone bridge 10, and the voltage potential at the nodes 12 and 14 will be different. The difference between the voltage potentials at the nodes 12 and 14 of the unbalanced bridge can be used to calculate the voltage state of a fuel cell.

FIG. 3 is a schematic diagram of a cell monitoring system 20 for monitoring the state of fuel cells 22 in a fuel cell stack 24 that uses the giant magnetoresistive phenomenon as discussed above, according to an embodiment of the present invention. In this embodiment, there are three fuel cells 22 electrically coupled in series, as representative of a suitable number for a fuel cell stack. However, as will be appreciated by those skilled in the art, the fuel cell stack 24 can include any suitable number of the fuel cells 22. The cell monitoring system 20 includes a giant magnetoresistive (GMR) device 28 having a wheatstone bridge 26 including four resistors 30 and output ports 32 and 34. All of the resistors 30 in the wheatstone bridge 26 are GMR resistors, however, two of the resistors 30 have magnetic shields 36 so that they are not effected by magnetic fields. The GMR device 28 is a commercially available device, for example, from the Nonvolatile Electronics Corp. By using two non-shielded magnetoresistive resistors, a greater differential voltage can be provided at the output ports 32 and 34 in response to a magnetic field.

The monitoring system 20 includes six field effect transistors (FETs) 38-48 electrically coupled to the fuel cells 22 and an electrical conductor 50, as shown. Two FETs are electrically coupled to the bipolar plate between adjacent fuel cells 22 so that the current flow through the conductor 50 is always in the same direction. In one embodiment, the conductor 50 is an electrical trace that is positioned under the GMR device 28. If no gate voltage is applied to the FETs 38-48, no current flows through the conductor 50, and the voltage potential at the output ports 32 and 34 is the same. Because the coupling method between the conductor 50 and the GMR device 28 is magnetic coupling, the GMR device 28 is electrically isolated from the high voltage of the fuel cell stack 24.

In this design, there are two FETs for each fuel cell 22. By applying a voltage to the gates of the FETs 38 and 44, the FETs 38 and 44 will turn on causing a current to flow through the conductor 50 from the potential difference between the positive and negative terminals of the first fuel cell 22. The current flow through the conductor 50 will produce a magnetic field. The magnetic field will upset the balance of the wheatstone bridge 26, and produce a measurable voltage difference at the output ports 32 and 34. The output ports 32 and 34 are electrically coupled to the inputs of a differencing amplifier 52. The amplifier 52 amplifies the difference between the voltages at the output ports 32 and 34, and provides an output signal that is a measurement of the voltage output of the first fuel cell 22. The output signal is sent to an analog-to-digital converter to be processed as a digital signal.

The gate voltages of the FETs 38 and 44 are then turned off, and the gate voltages of the FETs 40 and 46 are turned on to measure the voltage potential of the second fuel cell 22 at the output of the amplifier 52 in the same manner. Likewise, the gate voltages of the FETs 40 and 46 are turned off, and the gate voltages of the FETs 42 and 48 are turned on to measure the voltage potential of the third fuel cell 22 at the output of the amplifier 52. Therefore, each fuel cell 22 in the stack 24 can be separately and sequentially measured. The time period required between separate measurements for the same fuel cell 22 will determine how many of the GMR devices 28 are needed.

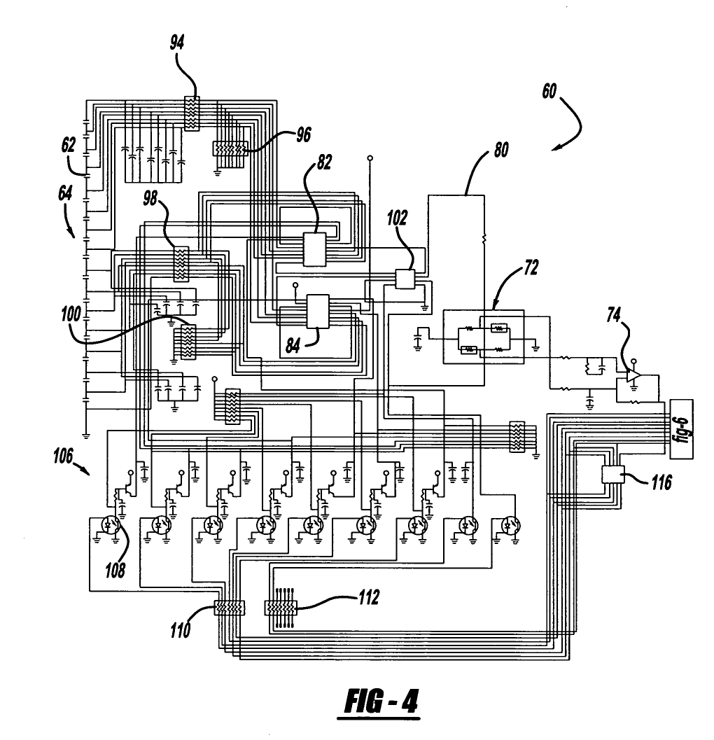

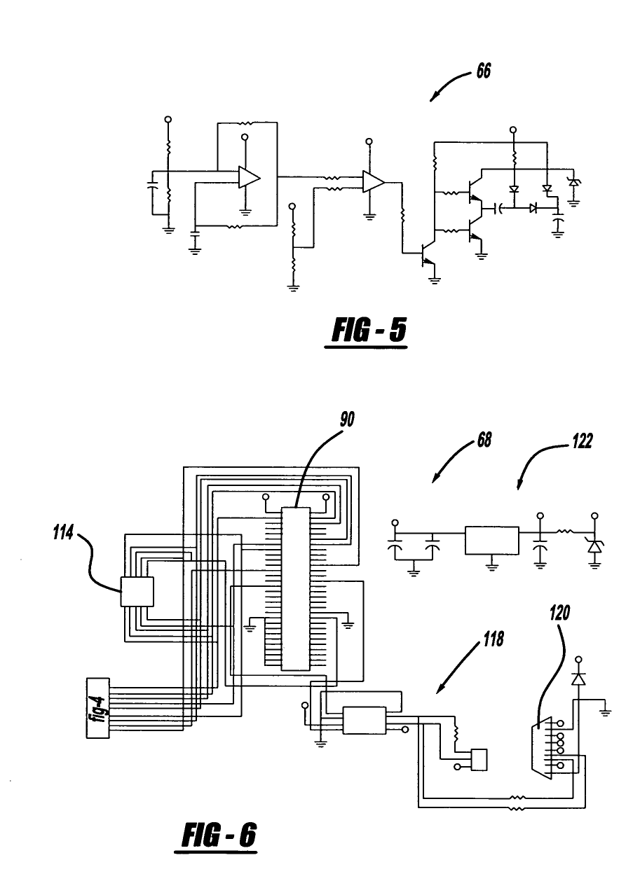

FIG. 4 is a detailed schematic diagram of a monitoring system 60, of the type discussed above, for monitoring fuel cells 62 in a fuel cell stack 64, according to another embodiment of the present invention. FIG. 5 is a schematic diagram of a charge pump 66 associated with the monitoring system 60 shown in FIG. 4, and FIG. 6 is a schematic diagram of a motherboard 68 associated with the monitoring system 60 shown in FIG. 4.

The monitoring system 60 includes a GMR device 72 and a differencing amplifier 74. The fuel cells 62 are selectively coupled to a conductor trace 80 positioned proximate the GMR device 72 by FET switch networks provided on integrated circuit chips 82 and 84. The monitoring system 60 and the switching of the FETS are controlled by a microcontroller 90. In one embodiment, the microcontroller 90 is the TMS 320LF2407 available from Texas Instruments. However, this is by way of anon-limiting example. The output of the amplifier 74 is sent to an analog-to-digital converter on the microprocessor 90.

The terminals of the fuel cells 62 are coupled to a particular voltage divider circuit provided on one of the integrated circuit chips 94, 96, 98 or 100 to voltage divide the cell voltages. An FET switch network on an integrated circuit chip 102 operates as a polarity reverser so that the terminals of the adjacent fuel cells 62 can be sequentially turned on and off and the direction of the current flow through the conductor 80 will stay the same. The system 60 further includes a decoder circuit 106 including a plurality of opto-isolators 108, as shown. The opto-isolators 108 isolate the high voltage fuel cell stack 64 from the low voltage microprocessor 90. The decoder circuit 106 turns on and off the FET switches on the chips 82 and 84 to selectively provide the current from each fuel cell 62 to the conductor 80. Two voltage divider chips 110 and 112 limit the current applied to the opto-isolators 108.

Two header connectors 114 and 116 connect the microprocessor 90 to the chips 110 and 112, and the output of the amplifier 74 to the microcontroller 90. A controller area network (CAN) transceiver 118 is connected to the controller 90 and a nine-pin connector 120, so that external signals can be sent to the microcontroller 90 for programming purposes and the like. A five-volt voltage regulator 122 provides 5V DC power to the low voltage components in the system 60. The charge pump circuit 66 provides a nominal 15 volts DC to the FET switch networks on the chips 82 and 84 in the event that the fuel cell stack 24 is not providing enough power for the chips 82 and 84, such as during vehicle acceleration.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A monitoring system for monitoring the voltage potential of fuel cells in a fuel cell stack, said system comprising:
a wheatstone bridge, said wheatstone bridge including at least one giant magnetoresistive (GMR) resistor and two output ports;
a conductor positioned proximate to the wheatstone bridge;
a plurality of switches electrically coupled to the fuel cells and to the conductor, said switches being selectively switched on and off to separately and selectively couple each fuel cell in the fuel cell stack to the conductor and generate a current flow therethrough, wherein a magnetic field generated by the current flow through the conductor reduces the resistance of the GMR resistor and unbalances the wheatstone bridge; and
a differencing amplifier electrically coupled to the output ports of the wheatstone bridge, said differencing amplifier providing an output signal indicative of the voltage potential of the selected fuel cell.

2. The system according to claim 1 wherein the switches are FET switches.

3. The system according to claim 1 wherein the at least one GMR resistor is two GMR resistors.

4. The system according to claim 1 wherein the conductor is an electrical trace positioned beneath the wheatstone bridge.

5. The system according to claim 1 further comprising a polarity reverser, said polarity reverser reversing the polarity of the current from the fuel cells before the current is applied to the conductor so that the current through the conductor is always in the same direction.

6. The system according to claim 1 further comprising at least one voltage divider electrically coupled between the fuel cells and the conductor.

7. The system according to claim 1 further comprising a controller for controlling the switches to separately measure the voltage potential of each fuel cell and for receiving the output signal from the amplifier.

8. The system according to claim 7 further comprising a plurality of opto-isolators for isolating the high voltage of the fuel cell stack and the switches from the low voltage of the controller.

9. The system according to claim 1 wherein the system monitors the fuel cell stack on a vehicle.

10. A monitoring system for monitoring the voltage potential of fuel cells in a fuel cell stack, said system comprising:
a wheatstone bridge, said wheatstone bridge including at least one giant magnetoresistive (GMR) resistor and two output ports;
an electrical trace positioned beneath the wheatstone bridge;
a plurality of FET switches electrically coupled to the fuel cells and to the trace, said FET switches being selectively switched on and off to separately and selectively couple each fuel cell in the fuel cell stack to the trace and generate a current flow therethrough, wherein a magnetic field generated by the current flow through the trace reduces the resistance of the GMR resistor and unbalances the wheatstone bridge;
a differencing amplifier electrically coupled to the output ports of the wheatstone bridge, said differencing amplifier providing an output signal indicative of the voltage potential of the selected fuel cell; and
a controller for controlling the switching of the FET switches to separately measure the voltage potential of each fuel cell and for receiving the output signal from the amplifier.

11. The system according to claim 10 further comprising a polarity reverser, said polarity reverser reversing the polarity of the current from the fuel cells before the current is applied to the trace so that the current through the trace is always in the same direction.

12. The system according to claim 10 further comprising at least one voltage divider electrically coupled between the fuel cells and the trace.

13. The system according to claim 10 further comprising a plurality of opto-isolators for isolating the high voltage of the fuel cell stack and the FET switches from the low voltage of the controller.

14. A method for monitoring the voltage potential of fuel cells in a fuel cell stack, said method comprising:
providing a wheatstone bridge including at least one giant magnetoresistive (GMR) resistor and two output ports;
providing a conductor positioned proximate to the wheatstone bridge;
selectively and separately electrically coupling the fuel cells to the conductor to generate a current flow through the conductor, wherein a magnetic field generated by the current flow through the conductor reduces the resistance of the GMR resistor and unbalances the wheatstone bridge; and
electrically coupling the output ports of the wheatstone bridge to a differencing amplifier, said differencing amplifier providing an output signal indicative of the voltage potential of the selected fuel cell.

15. The method according to claim 14 wherein selectively and separately electrically coupling the fuel cells to the conductor includes using FET switches to selectively and separately electrically couple the fuel cells to the conductor.

16. The method according to claim 14 wherein providing a conductor positioned proximate to the wheatstone bridge includes providing an electrical trace positioned beneath the wheatstone bridge.

17. The method according to claim 14 wherein providing a wheatstone bridge includes providing a wheatstone bridge including two GMR resistors.

18. The method according to claim 14 further comprising providing a polarity reverser for reversing the polarity of the current from the fuel cells before the current is applied to the conductor so that the current through the conductor is always in the same direction.

19. The method according to claim 14 further comprising providing at least one voltage divider electrically coupled between the fuel cells and the conductor.

20. The method according to claim 14 wherein the fuel cell stack is on a vehicle.
